(19) United States
(12) Patent Application Publication
(10) Pub. No.: US 2020/0363369 A1
(43) Pub. Date: Nov. 19, 2020

(54) GAS SENSOR ELEMENT AND GAS SENSOR

(71) Applicant: NGK SPARK PLUG CO., LTD., Nagoya-shi, Aichi (JP)

(72) Inventors: Mika TANGE, Nagoya-shi (JP); Keisuke NAKAGAWA, Nagoya-shi (JP); Takashi NAKAO, Nagoya-shi (JP); Shigehiro OHTSUKA, Nagoya-shi (JP)

(21) Appl. No.: 16/966,750

(22) PCT Filed: Sep. 12, 2018
(86) PCT No.: PCT/JP2018/033828

§ 371 Date: Jul. 31, 2020

(30) Foreign Application Priority Data
Feb. 14, 2018 (JP) 2018-024281

(51) Int. Cl. G01N 27/407; G01N 27/409

(52) U.S. Cl. CPC G01N 27/4075; G01N 27/4077; G01N 27/409; G01N 27/4073

(57) ABSTRACT

Provided are a gas sensor element which is not prone to decreased precision of gas detection due to a decrease in temperature of a gas to be measured, and a gas sensor. An aspect of the present invention is a gas sensor element for detecting a specific gas included in a gas to be measured, the gas sensor element being provided with a solid electrolyte, a reference electrode, a measurement electrode, and a gas restricting layer. The thickness dimension WA of a portion of the gas restricting layer that is in contact with the measurement electrode, the thickness dimension WB of a portion of the gas restricting layer that is in contact with the solid electrolyte, and the thickness dimension WC of the measurement electrode satisfy the conditions WB>WA and WB−WA>WC. In a gas sensor element provided with such a gas restricting layer, the heat capacity of the gas restricting layer can be increased without hindering the gas to be measured from reaching the measurement electrode. Through this gas sensor element, the amount of change in temperature of the gas sensor element can be reduced and a decrease in gas detection precision can be mitigated even when the temperature of the gas to be measured is reduced.

### TECHNICAL FIELD

The present disclosure relates to a gas sensor element and a gas sensor.

### BACKGROUND ART

There is a gas sensor element adapted to detect a specific gas contained in a gas under measurement and including a closed-end tubular solid electrolyte body and a pair of electrodes (measurement electrode (outer electrode) and reference electrode (inner electrode)) provided on the outside and inside, respectively, of the solid electrolyte body, as well as a gas sensor including such a gas sensor element.

There has been proposed such a gas sensor element including a protective layer (gas limitation layer) that covers the measurement electrode and allows permeation of the gas under measurement and whose thickness on the forward end of the element is greater than that on the side surface of the element (Patent Document 1). Such a gas sensor element exhibits low cost and an excellent resistance to adhesion of water and an excellent response performance.

### PRIOR ART DOCUMENT

### Patent Document

Patent Document 1: Japanese Patent Application Laid-Open (kokai) No. 2010-151575

### SUMMARY OF THE INVENTION

### Problem to be Solved by the Invention

However, the above-mentioned gas sensor element involves the following potential problem: in the event of a drop in the temperature of the gas under measurement (e.g., exhaust gas), the temperature of the gas sensor element (specifically, a forward end portion of the solid electrolyte body, the measurement electrode, and the reference electrode) drops, leading to deterioration in an activated state of the gas sensor element with a resultant deterioration in accuracy in gas detection.

Such a deterioration in accuracy in gas detection may arise even in a gas sensor having a heater for heating the gas sensor element. In the case of a gas sensor having a heaterless structure in which the gas sensor element is activated by heat conducted from the gas under measurement, there increases the possibility of deterioration in accuracy in gas detection stemming from a drop in the temperature of the gas sensor element as a result of a drop in the temperature of the gas under measurement.

An object of the present disclosure is to provide a gas sensor element and a gas sensor that are unlikely to suffer deterioration in accuracy in gas detection stemming from a drop in the temperature of the gas under measurement.

### Means for Solving the Problem

One mode of the present disclosure is a gas sensor element for detecting a specific gas contained in a gas under measurement, comprising a solid electrolyte body, a reference electrode, a measurement electrode, and a gas limitation layer. The solid electrolyte body is formed into a closed-end tubular shape having a closed forward end and an open rear end, and contains zirconia. The reference electrode is formed on an inner surface of a forward end portion of the solid electrolyte body. The measurement electrode is formed on an outer surface of the forward end portion of the solid electrolyte body. The gas limitation layer is in contact with and covers the measurement electrode, and is in contact with and covers at least a portion of the solid electrolyte body.

The gas sensor element satisfies a condition “WB>WA and WB−WA>WC,” where WA is the thickness of a portion of the gas limitation layer, which portion is in contact with the measurement electrode, WB is the thickness of a portion of the gas limitation layer, which portion is in contact with the solid electrolyte body, and WC is the thickness of the measurement electrode.

In the gas limitation layer that satisfies the above-mentioned condition, the thickness WB of the portion in contact with the solid electrolyte body is greater than the total thickness of the thickness WA of the portion in contact with the measurement electrode and the thickness WC of the measurement electrode (WB>WA+WC). Such a gas limitation layer can increase thermal capacity at the portion in contact with the solid electrolyte body as compared with the portion in contact with the measurement electrode while maintaining permeation of the gas under measurement at the portion in contact with the measurement electrode.

The gas sensor element having such a gas limitation layer can increase the thermal capacity thereof without hindering the gas under measurement from reaching the measurement electrode. That is, even in the event of a drop in the temperature of the gas under measurement, the gas sensor element can reduce the amount of temperature change thereof by means of thermal capacity of the gas limitation layer.

Therefore, since the gas sensor element can reduce the amount of temperature change thereof stemming from a drop in the temperature of the gas under measurement without hindering the gas under measurement from reaching the measurement electrode, deterioration in accuracy in gas detection can be mitigated.

Notably, the term “thickness” used herein means a dimension in a direction perpendicular to the surface of the solid electrolyte body. For example, the thickness WA is a dimension between the inner surface and the outer surface of the gas limitation layer at the portion in contact with the measurement electrode as measured in a direction perpendicular to the surface of the solid electrolyte body. The thickness WB is a dimension between the inner surface and the outer surface of the gas limitation layer at the portion in contact with the solid electrolyte body as measured in a direction perpendicular to the surface of the solid electrolyte body. The thickness WC is a dimension between the inner surface and the outer surface of the measurement electrode as measured in a direction perpendicular to the surface of the solid electrolyte body.

Next, in the above-mentioned gas sensor element, the gas limitation layer may be in contact with and cover at least a portion of a region of the solid electrolyte body located rearward of the measurement electrode. Such a gas limitation layer can increase thermal capacity in the region of the solid electrolyte body located rearward of the measurement electrode. As a result, even in the event of a drop in the temperature of the gas under measurement, the gas sensor element can reduce the amount of temperature change in the region of the solid electrolyte body located rearward of the measurement electrode and can reduce the amount of temperature change in a region of the solid electrolyte body where the measurement electrode is formed, by virtue of transmission of heat in the solid electrolyte body from the rearward region to the region where the measurement electrode is formed. Therefore, the gas sensor element can further reduce the amount of temperature change thereof stemming from a drop in the temperature of the gas under measurement and thus can further mitigate deterioration in accuracy in gas detection.

Next, in the above-mentioned gas sensor element, the solid electrolyte body may have a protrusion protruding radially outward in a region of an outer surface thereof located rearward of the measurement electrode. The gas limitation layer may cover at least a region of an outer surface of the solid electrolyte body located rearward of the measurement electrode, the region being located forward of a specific position between the measurement electrode and the protrusion.

Since the portion of the gas limitation layer in contact with the solid electrolyte body is located at least in a predetermined region located forward of the specific position, the gas limitation layer can reduce the amount of temperature change of the gas sensor element in the predetermined region. As a result, even in the event of a drop in the temperature of the gas under measurement, the gas sensor element can reduce the amount of temperature change in the predetermined region of the solid electrolyte body and can reduce the amount of temperature change in a region of the solid electrolyte body where the measurement electrode is formed, by virtue of transmission of heat in the solid electrolyte body from the predetermined region to the region where the measurement electrode is formed. Therefore, the gas sensor element can further reduce the amount of temperature change thereof stemming from a drop in the temperature of the gas under measurement and thus can further mitigate deterioration in accuracy in gas detection.

Next, in the above-mentioned gas sensor element having the protrusion, the specific position may correspond to a value of 23% or more with a value of 100% representing a dimension from the measurement electrode to the protrusion on the outer surface of the solid electrolyte body.

According to the test results (FIGS. 5 and 6) to be described later, by setting the specific position to a position corresponding to a value of 23% or more, there can be reduced the amount of temperature change of the gas sensor element stemming from a drop in the temperature of the gas under measurement.

Notably, the specific position may be set to a position corresponding to a value of 50% or more. Further, the specific position may be set to a position corresponding to a value of 100%; i.e., the gas limitation layer may cover the entire outer surface of the solid electrolyte body between the measurement electrode and the protrusion.

Next, in the above-mentioned gas sensor element, the gas limitation layer may have a thermal conductivity equal to or lower than that of the solid electrolyte body.

Employment of such a gas limitation layer can reduce the amount of temperature change of the solid electrolyte body in the event of a drop in the temperature of the gas under measurement and thus can restrain deterioration in accuracy in gas detection stemming from the drop in the temperature of the gas under measurement.

Next, the above-mentioned gas sensor element may further comprise a catalyst layer covering at least a forward end portion of the gas limitation layer and containing a noble metal catalyst.

In the gas sensor element, as a result of employment of the catalyst layer, at least a portion of the gas under measurement reaching the measurement electrode initiates a gas equilibration reaction in the catalyst layer, thereby assisting the gas equilibration reaction in the measurement electrode. As a result, even in the event of a deterioration in an activated state of the solid electrolyte body, gas detection is enabled, whereby accuracy in gas detection can be improved.

Another mode of the present disclosure is a gas sensor comprising a gas sensor element for detecting a specific gas contained in a gas under measurement, wherein the gas sensor element is any one of the above-mentioned gas sensor elements.

Similar to the above-mentioned gas sensor element, since the present gas sensor can reduce the amount of temperature change thereof stemming from a drop in the temperature of the gas under measurement without hindering the gas under measurement from reaching the measurement electrode, deterioration in accuracy in gas detection can be mitigated.

Notably, the gas sensor may have a heaterless structure having no heater for heating the gas sensor element.

### BRIEF DESCRIPTION OF THE DRAWINGS

FIG. 1 Explanatory view showing a gas sensor sectioned along an axial line O.

FIG. 2 Front view showing the external appearance of a gas sensor element as viewed before formation of a protective layer.

FIG. 3 Cross-sectional view showing the structure of the gas sensor element.

FIG. 4 Enlarged cross-sectional view showing a region D1 of the gas sensor element enclosed by a dotted line in FIG. 3.

FIG. 5 Table showing the results of an evaluation test conducted for evaluating temperature change characteristics of the gas sensor elements.

FIG. 6 Explanatory graph showing the interrelationship between the length LE2 of a low-thermal-conductivity layer and the amount of temperature change ΔT of a forward end portion 25 in the test results regarding temperature change characteristics of the gas sensor elements.

### MODES FOR CARRYING OUT THE INVENTION

Embodiments to which the present disclosure is applied will next be described with reference to the drawings. The present disclosure is not limited to the following embodiments, but can be embodied in various modes without departing from the technical scope of the present disclosure.

### 1. First Embodiment

[1-1. Overall Structure]

A first embodiment will be described while referring to an oxygen sensor (hereinafter, may be called a gas sensor 1) that is attached to an exhaust pipe of an internal combustion engine with a forward end portion thereof protruding into the exhaust pipe, for detecting oxygen contained in exhaust gas. A gas sensor 1 of the present embodiment is attached to an exhaust pipe of a vehicle such as an automobile or a motorcycle and detects the concentration of oxygen contained in exhaust gas in the exhaust pipe.

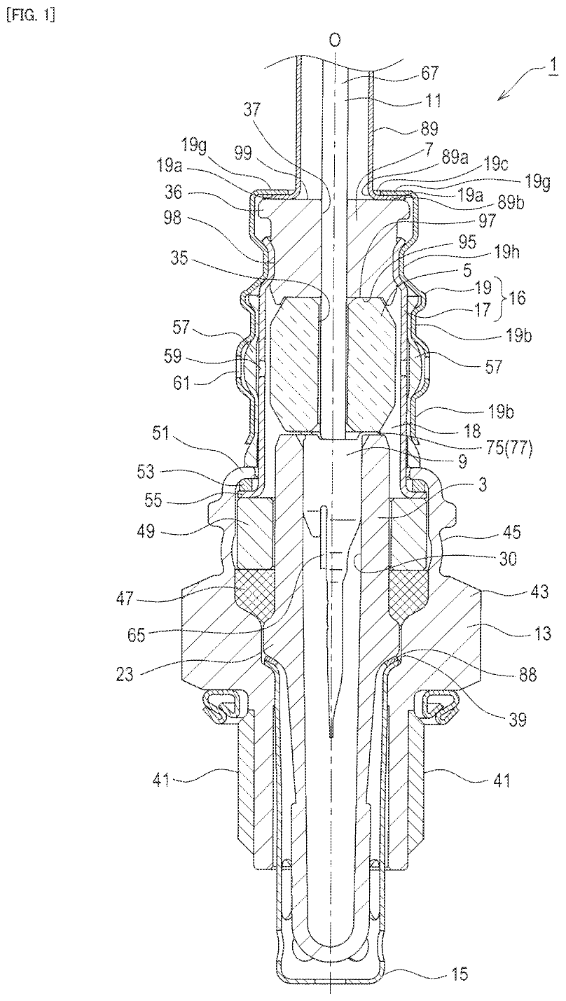

First, the structure of the gas sensor 1 of the present embodiment will be described with reference to FIG. 1.

In FIG. 1, a lower side of the drawing corresponds to a forward end side of the gas sensor, and an upper side corresponds to a rear end side of the gas sensor.

The gas sensor 1 includes a gas sensor element 3, a separator 5, a plug member 7, a metallic terminal 9, and a lead wire 11. The gas sensor 1 further includes a metallic shell 13, a protector 15, and a sleeve 16, which are disposed in such a manner as to surroundingly cover the gas sensor element 3, the separator 5, and the plug member 7. Notably, the sleeve 16 includes an inner sleeve 17 and an outer sleeve 19.

The gas sensor 1 is a so-called heaterless sensor having no heater for heating the gas sensor element 3 and which activates the gas sensor element 3 by utilizing heat of the exhaust gas for detecting oxygen.

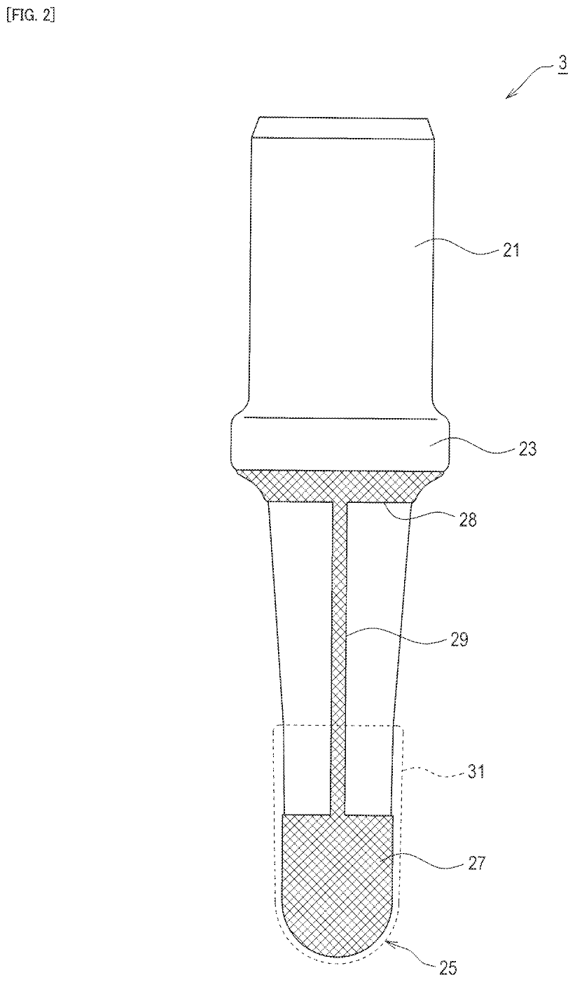

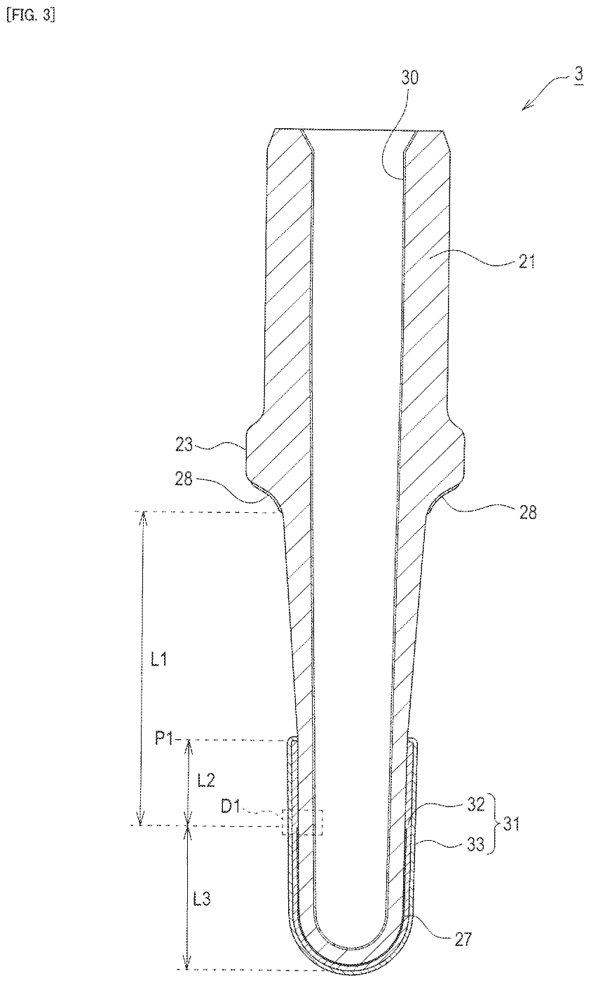

FIG. 2 is a front view showing the external appearance of the gas sensor element 3 as viewed before formation of a protective layer 31. In FIG. 2, the dotted line indicates a region in which the protective layer 31 is formed. FIG. 3 is a cross-sectional view showing the structure of the gas sensor element 3.

The gas sensor element 3 is formed using a solid electrolyte body having oxygen ion conductivity, has a closed-end tubular shape having a closed forward end portion 25, and includes a cylindrical element body 21 extending in the direction of an axial line O. An element flange portion 23 extending circumferentially and protruding radially outward is formed on the outer circumference of the element body 21.

Notably, the solid electrolyte body forming the element body 21 is formed using a partially stabilized zirconia sintered body prepared by adding yttria (Y₂O₃) or calcia (CaO) serving as a stabilizer to zirconia (ZrO₂). The solid electrolyte body forming the element body 21 is not limited thereto. “A solid solution of ZrO₂ and an oxide of an alkaline earth metal,” “a solid solution of ZrO₂ and an oxide of a rare earth metal,” etc., may be used. Further, these solid solutions to which HfO₂ is added may also be used as the solid electrolyte body forming the element body 21.

The gas sensor element 3 has an outer electrode 27 (see FIG. 3) formed on the outer circumferential surface of the element body 21 at the forward end portion 25 of the gas sensor element 3. The outer electrode 27 is formed porously from Pt or a Pt alloy. The outer electrode 27 is covered with the porous protective layer 31. However, in FIG. 2, the protective layer 31 is illustrated in a transparent manner such that the outer electrode 27 is visible.

An annular lead portion 28 is formed of Pt or the like on the forward end side (lower side in FIG. 2) of the element flange portion 23. A longitudinal lead portion 29 extending in the axial direction is formed of Pt or the like on the outer circumferential surface of the element body 21 between the outer electrode 27 and the annular lead portion 28. The longitudinal lead portion 29 electrically connects the outer electrode 27 and the annular lead portion 28.

As shown in FIG. 3, an inner electrode 30 is formed on the inner circumferential surface of the element body 21 of the gas sensor element 3. The inner electrode 30 is formed porously from Pt or a Pt alloy. At the forward end portion 25 (detecting portion) of the gas sensor element 3, the outer electrode 27 is exposed to the gas under measurement through the protective layer 31, and the inner electrode 30 is exposed to a reference gas (atmosphere), thereby detecting the oxygen concentration of the gas under measurement.

As shown in FIG. 1, the separator 5 is a cylindrical member formed of an electrically insulating material (e.g., alumina). The separator 5 has, at its axial center, a through hole 35 through which the lead wire 11 is passed. The separator 5 is disposed such that a gap 18 is formed between the separator 5 and the inner sleeve 17 that covers the outer circumference of the separator 5.

The plug member 7 is a cylindrical seal member formed of an electrically insulating material (e.g., fluorocarbon rubber). The plug member 7 has a protruding portion 36 protruding radially outward from the rear end thereof. The plug member 7 has, at its axial center, a lead wire insertion hole 37 through which the lead wire 11 is passed. A forward end surface 95 of the plug member 7 is in intimate contact with a rear end surface 97 of the separator 5. The plug member 7 has a side circumferential surface 98 which is located forward of the protruding portion 36 and is in intimate contact with the inner surface of the inner sleeve 17. Namely, the plug member 7 closes the rear end of the sleeve 16.

A flange portion 89b of a lead wire protective member 89 is sandwiched between a rearward facing surface 99 of the plug member 7 and a forward facing surface 19a of a diameter-reducing portion 19g of the outer sleeve 19. The diameter-reducing portion 19g is located rearward of the plug member 7 and extends radially inward, and the forward facing surface 19a of the diameter-reducing portion 19g is formed as a surface facing toward the forward end side of the gas sensor 1. The diameter-reducing portion 19g has a lead wire insertion portion 19c which is formed in a central region thereof and into which the lead wire 11 and the lead wire protective member 89 are inserted.

The lead wire protective member 89 is a tubular member having an inner diameter that allows the lead wire 11 to be contained in the lead wire protective member 89 and is formed from a flexible, heat resistant, and insulating material (e.g., a glass or resin tube). The lead wire protective member 89 is provided so as to protect the lead wire 11 from objects (stones, water, etc.) flying from the outside.

The plate-shaped flange portion 89b protruding outward in a direction perpendicular to the axial direction is provided at a forward end 89a of the lead wire protective member 89. The flange portion 89b is formed not in part of the circumference of the lead wire protective member 89 but over the entire circumference.

The flange portion 89b of the lead wire protective member 89 is sandwiched between the forward facing surface 19a of the diameter-reducing portion 19g of the sleeve 16 (specifically, the outer sleeve 19) and the rearward facing surface 99 of the plug member 7. The metallic terminal 9 is a tubular member formed of an electrically conductive material (e.g., INCONEL 750 (trademark, International Nickel Company U.K.)) and is used for taking the output of the sensor to the outside. The metallic terminal 9 is electrically connected to the lead wire 11 and disposed so as to be in electrical contact with the inner electrode 30 of the gas sensor element 3. The metallic terminal 9 has, at its rear end, a flange portion 77 protruding radially outward (in a direction perpendicular to the axial direction). The flange portion 77 includes three plate-shaped flange pieces 75.

The lead wire 11 includes a core wire 65 and a cover portion 67 covering the outer circumference of the core wire 65.

The metallic shell 13 is a cylindrical member formed of a metallic material (e.g., iron or SUS430). The metallic shell 13 has, on its inner circumferential surface, a step portion 39 protruding radially inward. The step portion 39 is formed in order to support the element flange portion 23 of the gas sensor element 3.

The metallic shell 13 has a threaded portion 41 formed on the outer circumferential surface of a forward end portion thereof. The threaded portion 41 is used for attaching the gas sensor 1 to an exhaust pipe. The metallic shell 13 has a hexagonal portion 43 formed rearward of the threaded portion 41. When the gas sensor 1 is attached to or detached from the exhaust pipe, a mounting tool is engaged with the hexagonal portion 43. Further, the metallic shell 13 has a tubular portion 45 provided rearward of the hexagonal portion 43.

The protector 15 is formed of a metallic material (e.g., SUS310S) and is a protective member covering a forward end portion of the gas sensor element 3. The protector 15 is fixed such that its rear end is held between the element flange portion 23 of the gas sensor element 3 and the step portion 39 of the metallic shell 13 through a packing 88.

In a region rearward of the element flange portion 23 of the gas sensor element 3, a ceramic powder 47 made of talc and a ceramic sleeve 49 made of alumina are disposed from the forward end side toward the rear end side between the metallic shell 13 and the gas sensor element 3.

Moreover, a metal ring 53 formed of a metallic material (e.g., SUS430) and a forward end portion 55 of the inner sleeve 17 that is formed of a metallic material (e.g., SUS304L) are disposed inside a rear end portion 51 of the tubular portion 45 of the metallic shell 13. The forward end portion 55 of the inner sleeve 17 is formed into a shape extending radially outward. Namely, when the rear end portion 51 of the tubular portion 45 is crimped, the forward end portion 55 of the inner sleeve 17 is sandwiched between the rear end portion 51 of the tubular portion 45 and the ceramic sleeve 49 through the metal ring 53, and the inner sleeve 17 is thereby fixed to the metallic shell 13.

Also, a tubular filter 57 formed of a resin material (e.g., PTFE) is disposed on the outer circumference of the inner sleeve 17, and the outer sleeve 19 formed of, for example, SUS304L is disposed on the outer circumference of the filter 57. The filter 57 allows air to pass therethrough but can prevent intrusion of water.

When a crimp portion 19b of the outer sleeve 19 is crimped radially inward from the outer circumferential side, the inner sleeve 17, the filter 57, and the outer sleeve 19 are fixed integrally. Also, when a crimp portion 19h of the outer sleeve 19 is crimped radially inward from the outer circumferential side, the inner sleeve 17 and the outer sleeve 19 are fixed integrally, and the side circumferential surface 98 of the plug member 7 comes into intimate contact with the inner surface of the inner sleeve 17.

Notably, the inner sleeve 17 and the outer sleeve 19 have vent holes 59 and 61, respectively. Air can flow between the space inside the gas sensor 1 and the space outside the gas sensor 1 through the vent holes 59 and 61 and the filter 57.

[1-2. Gas Sensor Element]

The structure of the gas sensor element 3 will be described.

As mentioned above, the gas sensor element 3 includes the element body 21, the outer electrode 27, the annular lead portion 28, the longitudinal lead portion 29, the inner electrode 30, and the protective layer 31.

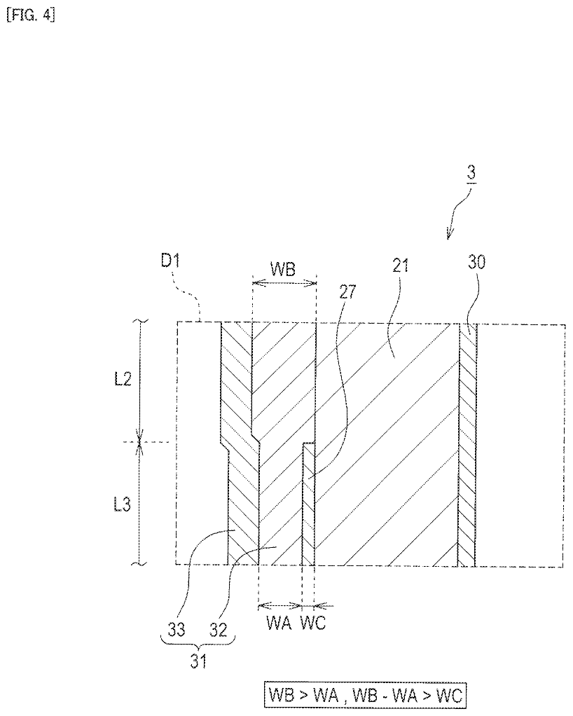

FIG. 4 is an enlarged cross-sectional view showing a region D1 of the gas sensor element 3 enclosed by a dotted line in FIG. 3.

At the forward end portion 25 of the gas sensor element 3, the outer electrode 27 and the inner electrode 30 are disposed such that they sandwich the element body 21.

The protective layer 31 is formed in such a manner as to cover the outer electrode 27. The protective layer 31 includes a low-thermal-conductivity layer 32 and a catalyst-containing layer 33. In the protective layer 31, the low-thermal-conductivity layer 32 is disposed closer to the outer electrode 27 than the catalyst-containing layer 33.

The low-thermal-conductivity layer 32 is in contact with and covers at least a portion of a region of the element body 21 located rearward of the outer electrode 27. The low-thermal-conductivity layer 32 is formed of zirconia (5YSZ) stabilized by 5 mol % yttria. The low-thermal-conductivity layer 32 is formed porously to have a porosity of 13%. The low-thermal-conductivity layer 32 has a thermal conductivity of 2.0 [W/m·K].

Notably, the element body 21 has a thermal conductivity of 2.5 [W/m·K]. Accordingly, the low-thermal-conductivity layer 32 is lower in thermal conductivity than the element body 21.

The catalyst-containing layer 33 is formed of spinel (MgAl₂O₄) and titania (TiO₂). A noble metal (at least one of Pt, Pd, and Rh) is supported in the catalyst-containing layer 33. The noble metal functions as a catalyst for accelerating a gas equilibration reaction of various gases contained in exhaust gas. The catalyst-containing layer 33 is formed porously to have a porosity of 52%.

As shown in FIG. 3, in the gas sensor element 3, a first region L1 represents a region from the forward end position of the element flange portion 23 (protrusion) of the element body 21 (solid electrolyte body) to the rear end position of the outer electrode 27 (measurement electrode). A second region L2 represents a portion of the low-thermal-conductivity layer 32 (gas limitation layer), which portion is in contact with the element body 21 (solid electrolyte body). A third region L3 represents a portion of the low-thermal-conductivity-layer 32 (gas limitation layer), which portion is in contact with the outer electrode 27 (measurement electrode).

The thickness WA of the low-thermal-conductivity layer 32 at the portion in contact with the outer electrode 27 (in other words, the thickness WA of the low-thermal-conductivity layer 32 in the third region L3) is 100 μm. The thickness WB of the low-thermal-conductivity layer 32 at the portion in contact with the element body 21 (in other words, the thickness WB of the low-thermal-conductivity layer 32 in the second region L2) is 300 μm.

The thickness WC of the outer electrode 27 is 3 μm. The thickness of the element body 21 is 500 μm (region of detecting portion), and the thickness of the inner electrode 30 is 3 μm.

Notably, for explaining purpose, FIG. 3 schematically shows the structure of lamination of the layers and the electrodes. The relative ratios between thicknesses of the layers and the electrodes differ from the actual ones. The term “thickness” used herein means a dimension in a direction perpendicular to the surface of the element body 21. For example, the thickness WA is the dimension between the inner surface and the outer surface of the low-thermal-conductivity layer 32 at the portion in contact with the outer electrode 27 as measured in a direction perpendicular to the surface of the element body 21. The thickness WB is the dimension between the inner surface and the outer surface of the low-thermal-conductivity layer 32 at the portion in contact with the element body 21 as measured in a direction perpendicular to the surface of the element body 21. The thickness WC is the dimension between the inner surface and the outer surface of the outer electrode 27 as measured in a direction perpendicular to the surface of the element body 21.

The thickness WA, the thickness WB, and the thickness WC satisfy the condition “WB>WA and WB−WA>WC.”

The low-thermal-conductivity layer 32 covers at least the second region L2 of the outer surface of the element body 21. The second region L2 is a region of the outer surface of the element body 21 located rearward of the outer electrode 27, the region being located forward of a specific position P1 between the outer electrode 27 and the element flange portion 23.

In the present embodiment, the specific position P1 corresponds to a value of 23% with a value of 100% representing the dimension from the outer electrode 27 to the element flange portion 23 on the outer surface of the element body 21 (in other words, a length LE1 of the first region L1 in the axial direction). In other words, the axial dimension (length LE2) of the second region L2 corresponds to a value of 23% with a value of 100% representing the length LE1 of the first region L1.

[1-3. Method for Producing a Gas Sensor Element]

The method for producing the gas sensor element 3 will be described.

First, yttria (Y₂O₃) serving as a stabilizer is added in an amount of 5 mol % to zirconia (ZrO₂) to prepare a mixture (hereinafter referred to also as 5YSZ), and alumina powder is further added thereto to prepare a solid electrolyte powder used as the material of the element body 21. When the total amount of the powder of the material of the element body 21 is set to 100% by mass, the content of the 5YSZ is 99.6% by mass, and the content of the alumina powder is 0.4% by mass. The powder is subjected to pressing and then subjected to machining into a tubular shape to thereby obtain a green compact.

Next, slurries that contain platinum (Pt) and zirconia are applied to portions of the green compact where the outer electrode 27, the annular lead portion 28, the longitudinal lead portion 29, and the inner electrode 30 are to be formed.

The slurry for forming the outer electrode 27, the annular lead portion 28, and the longitudinal lead portion 29 is prepared by adding monoclinic zirconia in an amount of 15% by mass to platinum (Pt). The slurry for forming the inner electrode 30 is prepared by adding “mixed powder of 5YSZ (99.6% by mass) and alumina (0.4% by mass)” (same composition as that of the element body 21) in an amount of 15% by mass to platinum (Pt).

Next, the slurry for forming the low-thermal-conductivity layer 32 through firing is applied to the green compact by dipping in such a manner as to entirely cover the outer electrode 27, thereby forming a green low-thermal-conductivity layer 32. The slurry is prepared by adding carbon as a pore-forming material (pore generator) to the mixed powder of 5YSZ and 0.4% by mass alumina. The slurry contains the mixed powder of 5YSZ and 0.4% by mass alumina in an amount of 87% by volume and carbon in an amount of 13% by volume.

Next, the green compact with the slurries applied is subjected to a drying process and is then fired at 1,350° C. for one hour.

Next, a slurry for forming the catalyst-containing layer 33 through firing is applied by dipping to a fired body obtained by firing the green compact, in such a manner as to entirely cover the low-thermal-conductivity layer 32, thereby forming a green catalyst-containing layer 33. The slurry contains spinel powder and titania powder.

Next, after the fired body with the above slurry applied is subjected to a drying process and is then fired at 1,000° C. for one hour, thereby forming the catalyst-containing layer 33. Subsequently, after a portion of the fired body where the catalyst-containing layer 33 is formed is immersed in an aqueous solution that contains noble metals (platinum chloride solution+palladium nitrate+rhodium nitrate), the fired body is subjected to a drying process and then to heat treatment at 800° C.

The gas sensor element 3 is obtained by such a production process. The thus-produced gas sensor element 3 is assembled with the separator 5, the plug member 7, the metallic terminal 9, the lead wire 11, etc., thereby partially constituting the gas sensor 1.

[1-4. Evaluation test on gas sensor element] Next will be described the results of a test conducted for evaluating a temperature change characteristic of the gas sensor element to which the present disclosure is applied.

Herein, the “temperature change characteristic” is a characteristic indicative of the amount of temperature change in the forward end portion 25 of the gas sensor element 3 in the event of a drop in the temperature of the gas under measurement supplied to the gas sensor element 3. Notably, the smaller the amount of temperature change of the forward end portion 25 in response to a drop in the temperature of the gas under measurement, the stabler the activated state of the gas sensor element 3, whereby deterioration in accuracy in gas detection can be restrained.

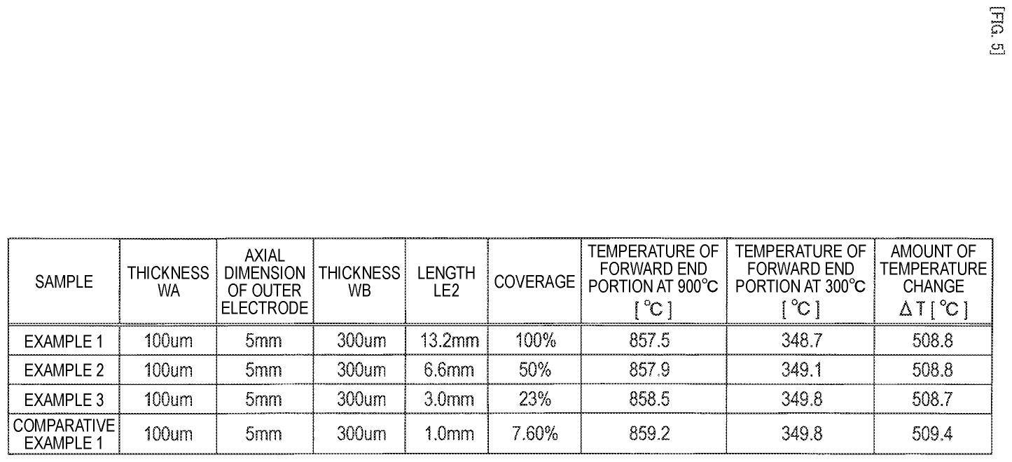

The present evaluation test measured the amount of temperature change ΔT of the forward end portion 25 in the event of a drop in the temperature of the gas under measurement supplied to the gas sensor element 3. For the present evaluation test, a plurality of the gas sensor elements 3 (three examples and one comparative example; see FIG. 5) that differed in the length LE2 of the low-thermal-conductivity layer 32 were prepared. The gas sensor elements 3 were measured for the amount of temperature change of the forward end portion 25. Notably, in each of the gas sensor elements 3 of the examples and the comparative example, the axial dimension of the outer electrode 27 was set to 5 mm.

The present evaluation test measured the amount of temperature change of the forward end portion 25 while the temperature of the gas under measurement was changed from 900° C. to 300° C. In this case, the temperature of the forward end portions 25 was measured after the temperature of the gas under measurement had been maintained at 900° C. for 30 sec and after the temperature of the gas under measurement had been maintained at 300° C. for 10 sec.

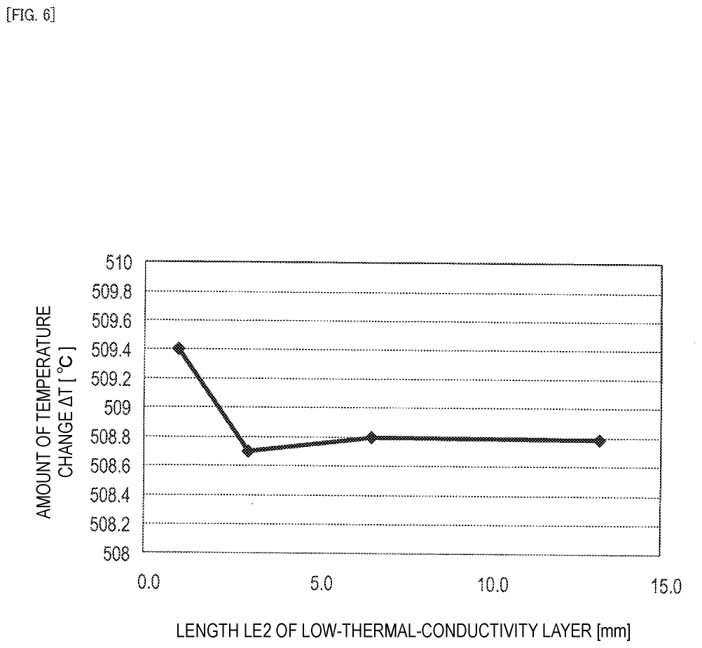

FIGS. 5 and 6 show the results of the present evaluation test. According to the evaluation test results, the amounts of temperature change ΔT of examples 1 to 3 are smaller than the amount of temperature change ΔT of comparative example 1. Therefore, the gas sensor elements 3 of examples 1 to 3 are stabler in activated state than the gas sensor element 3 of comparative example 1 and thus can restrain deterioration in accuracy in gas detection.

As shown in FIG. 5, in the gas sensor elements 3 of examples 1 to 3, the coverage of the element body 21 by the the low-thermal-conductivity layer 32 is set to 100%, 50%, and 23%, respectively. Notably, the term “coverage” used herein means the ratio of the region of the outer surface of the element body 21 covered by the low-thermal-conductivity layer 32 with a value of 100% representing the dimension from the outer electrode 27 to the element flange portion 27 on the outer surface of the element body 21. Therefore, by means of the low-thermal-conductivity layer 32 being formed in such a manner as to provide a coverage of 23% or more, there can be reduced the amount of temperature change of the gas sensor element 3 stemming from a drop in the temperature of the gas under measurement.

[1-5. Effects]

As described above, the gas sensor element 3 of the gas sensor 1 of the present embodiment satisfies the condition “WB>WA and WB−WA>WC,” where WA is the thickness of a portion (third region L3) of the low-thermal-conductivity layer 32 in contact with the outer electrode 27, WB is the thickness of a portion (second region L2) of the low-thermal-conductivity layer 32 in contact with the element body 21, and WC is the thickness of the outer electrode 27.

In the low-thermal-conductivity layer 32 that satisfies the condition, the thickness WB is greater than the total of the thickness WA and the thickness WC (WB>WA+WC). Such a low-thermal-conductivity layer 32 can increase thermal capacity at the portion in contact with the element body 21 as compared with the portion in contact with the outer electrode 27 while maintaining permeation of the gas under measurement at the portion in contact with the outer electrode 27.

The gas sensor element 3 having such a low-thermal-conductivity layer 32 can increase thermal capacity of the low-thermal-conductivity layer 32 without hindering the gas under measurement from reaching the outer electrode 27. That is, even in the event of a drop in the temperature of the gas under measurement, the gas sensor element 3 can reduce the amount of temperature change thereof by means of thermal capacity of the low-thermal-conductivity layer 32.

Therefore, since the gas sensor element 3 can reduce the amount of temperature change thereof stemming from a drop in the temperature of the gas under measurement without hindering the gas under measurement from reaching the outer electrode 27, deterioration in accuracy in gas detection can be mitigated.

Next, in the gas sensor element 3, the low-thermal-conductivity layer 32 is in contact with and covers at least a portion of the region of the element body 21, the region being located rearward of the outer electrode 27. Such a low-thermal-conductivity layer 32 can increase thermal capacity in the region of the element body 21 located rearward of the outer electrode 27. As a result, even in the event of a drop in the temperature of the gas under measurement, the gas sensor element 3 can reduce the amount of temperature change in the region of the element body 21 located rearward of the outer electrode 27.

Next, in the gas sensor element 3, the element body 21 has the element flange portion 23. The low-thermal-conductivity layer 32 covers at least the second region L2 of the element body 21 (in other words, a region of the outer surface of the element body 21 located rearward of the outer electrode 27, the region being located forward of the specific position P1 between the outer electrode 27 and the element flange portion 23).

Since the portion of the low-thermal-conductivity layer 32 in contact with the element body 21 is located at least in a predetermined region (second region L2) located forward of the specific position P1, the low-thermal-conductivity layer 32 can reduce the amount of temperature change of the gas sensor element 3 in the second region L2. As a result, the gas sensor element 3 can further reduce the amount of temperature change thereof stemming from a drop in the temperature of the gas under measurement and thus can further mitigate deterioration in accuracy in gas detection.

Next, in the gas sensor element 3, the specific position P1 corresponds to a value of 23% with a value of 100% representing the length LE1 of the first region L1 on the outer surface of the element body 21. According to the above-mentioned test results, since the specific position P1 is set to a position corresponding to a value of 23% or more, the gas sensor element 3 can reduce the amount of temperature change thereof stemming from a drop in the temperature of the gas under measurement.

Next, in the gas sensor element 3, the thermal conductivity of the low-thermal-conductivity layer 32 is equal to or lower than that of the element body 21. Employment of such a low-thermal-conductivity layer 32 can reduce the amount of temperature change of the element body 21 in the event of a drop in the temperature of the gas under measurement and thus can restrain deterioration in accuracy in gas detection stemming from the drop in the temperature of the gas under measurement.

Next, the gas sensor element 3 has the catalyst-containing layer 33. The catalyst-containing layer 33 covers at least a forward portion of the low-thermal-conductivity layer 32 and contains a noble metal catalyst. In the gas sensor element 3, as a result of employment of the catalyst-containing layer 33, at least a portion of the gas under measurement reaching the outer electrode 27 initiates a gas equilibration reaction in the catalyst-containing layer 33, thereby assisting the gas equilibration reaction in the outer electrode 27. As a result, even in the event of a deterioration in an activated state of the element body 21, gas detection is enabled, whereby accuracy in gas detection can be improved.

Since, through employment of the gas sensor element 3, the gas sensor 1 can reduce the amount of temperature change thereof stemming from a drop in the temperature of the gas under measurement without hindering the gas under measurement from reaching the outer electrode 27, deterioration in accuracy in gas detection can be mitigated.

[1-6. Wording Correspondence]

The wording correspondence between the present embodiment and claims will be described.

The gas sensor 1 corresponds to an example of the gas sensor; the gas sensor element 3 corresponds to an example of the gas sensor element; the element body 21 corresponds to an example of the solid electrolyte body; the outer electrode 27 corresponds to an example of the measurement electrode; and the inner electrode 30 corresponds to an example of the reference electrode.

The low-thermal-conductivity layer 32 corresponds to an example of the gas limitation layer; the catalyst-containing layer 33 corresponds to an example of the catalyst layer; and the element flange portion 23 corresponds to an example of the protrusion.

### 2. Other Embodiments

While the present invention has been described with reference to the above embodiment, the present invention is not limited thereto, but may be embodied in various other modes without departing from the gist of the invention.

In the above embodiment, various numerical values (thermal conductivity, thickness, porosity, etc.) are specified for the protective layer and the element body (solid electrolyte body), etc. However, these numerical values are not limited to those mentioned above, but can be arbitrary so long as they are encompassed by the technical scope of the present invention. For example, thermal conductivity of the low-thermal-conductivity layer is not necessarily lower than that of the element body (solid electrolyte body), but may be equal to that of the element body (solid electrolyte body).

Further, the thickness WA and the thickness WB of the low-thermal-conductivity layer 32 and the thickness WC of the outer electrode 27 may assume any values so long as the condition “WB>WA and WB−WA>WC” is satisfied. The specific position P1 is not limited to the position corresponding to a value of 23% with a value of 100% representing the dimension of the first region L1, but may be a position corresponding to a value of 23% or more.

Next, the structure of the protective layer is not limited to a structure having the low-thermal-conductivity layer and the catalyst-containing layer, but the protective layer may have the low-thermal-conductivity layer only. Alternatively, the structure of the protective layer is not limited to a structure having the low-thermal-conductivity layer and the catalyst-containing layer only, but the protective layer may further have another layer. For example, the protective layer 31 of the first embodiment may further have a catalyst protection layer that entirely covers the catalyst-containing layer 33. Employment of the catalyst protection layer can restrain sublimation of a catalytic component (noble metal) in the catalyst-containing layer, thereby restraining deterioration in accuracy in gas detection which could otherwise result from sublimation of a catalytic component (noble metal).

Next, the above embodiment has been described while referring to a heaterless gas sensor. However, the gas sensor to which the present invention is applied may be a gas sensor with a heater for heating the gas sensor element. Such a gas sensor can efficiently utilize heat from exhaust gas, in addition to heating by the heater, for activating the gas sensor element and thus can detect gas even in a low-temperature (300° C. or lower) environment.

Examples of such a heater include a rod-shaped heater in contact with the tubular inner surface of a closed-end tubular gas sensor element, and a plate-shaped heater stacked on a plate-shaped gas sensor element.

Next, the function of one constituent element in the above embodiments may be distributed to a plurality of constituent elements, or the functions of a plurality of constituent elements may be realized by one constituent element. Part of the configurations of the above embodiments may be omitted. Also, at least part of the configuration of each of the above embodiments may be added to or partially replace the configurations of other embodiments. Notably, all modes included in the technical idea specified by the wording of the claims are embodiments of the present disclosure.

### DESCRIPTION OF REFERENCE NUMERALS

1: gas sensor; 3: gas sensor element; 13: metallic shell; 15: protector; 21: element body; 23: element flange portion; 25: forward end portion; 27: outer electrode; 28: annular lead portion; 29: longitudinal lead portion; 30: inner electrode; 31: protective layer; 32: low-thermal-conductivity layer; and 33: catalyst-containing layer.

What is claimed is:

1. A gas sensor element for detecting a specific gas contained in a gas under measurement, comprising:
a closed-end tubular solid electrolyte body having a closed forward end and an open rear end and containing zirconia;
a reference electrode formed on an inner surface of a forward end portion of the solid electrolyte body;
a measurement electrode formed on an outer surface of the forward end portion of the solid electrolyte body; and
a gas limitation layer which is in contact with and covers the measurement electrode and which is in contact with and covers at least a portion of the solid electrolyte body;
wherein a condition “WB>WA and WB−WA>WC” is satisfied, where WA is a thickness of a portion of the gas limitation layer, which portion is in contact with the measurement electrode, WB is a thickness of a portion of the gas limitation layer, which portion is in contact with the solid electrolyte body, and WC is a thickness of the measurement electrode.

2. A gas sensor element according to claim 1, wherein the gas limitation layer is in contact with and covers at least a portion of a region of the solid electrolyte body located rearward of the measurement electrode.

3. A gas sensor element according to claim 1, wherein the solid electrolyte body has a protrusion protruding radially outward in a region of an outer surface thereof located rearward of the measurement electrode, and
the gas limitation layer covers at least a region of an outer surface of the solid electrolyte body located rearward of the measurement electrode, the region being located forward of a specific position between the measurement electrode and the protrusion.

4. A gas sensor element according to claim 3, wherein the specific position corresponds to a value of 23% or more with a value of 100% representing a dimension from the measurement electrode to the protrusion on the outer surface of the solid electrolyte body.

5. A gas sensor element according to claim 1, wherein the gas limitation layer has a thermal conductivity equal to or lower than that of the solid electrolyte body.

6. A gas sensor element according to claim 1, further comprising a catalyst layer covering at least a forward end portion of the gas limitation layer and containing a noble metal catalyst.

7. A gas sensor comprising a gas sensor element for detecting a specific gas contained in a gas under measurement,
wherein the gas sensor element is a gas sensor element according to claim 1.
